(19) United States
(12) Patent Application Publication
(10) Pub. No.: US 2025/0231444 A1
(43) Pub. Date: Jul. 17, 2025

(54) LIQUID CRYSTAL ELEMENT

(71) Applicant: Japan Display Inc., Tokyo (JP)

(72) Inventors: Shunichi KIMURA, Tokyo (JP); Toshiharu MATSUSHIMA, Tokyo (JP)

(21) Appl. No.: 19/022,370

(22) Filed: Jan. 15, 2025

(30) Foreign Application Priority Data
Jan. 17, 2024 (JP) 2024-005675

(51) Int. Cl. G02F 1/1343; G02F 1/1333; G02F 1/1335; G02F 1/1339

(52) U.S. Cl. CPC G02F 1/134309; G02F 1/133345; G02F 1/133512; G02F 1/1339

(57) ABSTRACT

According to an aspect, a liquid crystal element includes a first substrate, a second substrate, and a liquid crystal layer between the first and second substrates. The first substrate includes: electric resistance films each having a shape with a length in a first direction being longer than a length in a second direction; first electrodes each including a first trunk part and first branch parts; and second electrodes each including a second trunk part and second branch parts. Each electric resistance film is provided such that: the first and second trunk parts are disposed on sides opposite each other with the electric resistance film between the trunk parts in the first direction; and the first and second branch parts are electrically coupled to the electric resistance film in a state of facing each other in the second direction.

### CROSS-REFERENCE TO RELATED APPLICATION

This application claims the benefit of priority from Japanese Patent Application No. 2024-005675 filed on Jan. 17, 2024, the entire contents of which are incorporated herein by reference.

### BACKGROUND

### 1. Technical Field

What is disclosed herein relates to a liquid crystal element.

### 2. Description of the Related Art

WO 2016/117604 discloses a liquid crystal element configured to refract incident light and emit the light. In the liquid crystal element, when voltage is applied to a first electrode and a second electrode, potential gradient is generated in a high-resistance layer, and liquid crystal molecules are tilted. Incident light is refracted due to the tilt of the liquid crystal molecules.

The first and second electrodes have linear shapes extending in a state of being parallel to each other. The high-resistance layer overlaps the first and second electrodes in a plan view. The direction of the potential gradient is orthogonal to the direction in which the electrodes (first and second electrodes) extend.

In the liquid crystal element of WO 2016/117604, when a resistance ratio described below is relatively small, a potential gradient is not appropriately generated in the high-resistance layer (electric resistance film), and light is not appropriately refracted. The resistance ratio is the ratio of the electric resistance value of the electric resistance film in the direction of the potential gradient to the electric resistance value of an electrode in a direction orthogonal to the potential gradient. In the electric resistance film, the resistance ratio decreases as the length of a portion between the first and second electrodes in the direction of the potential gradient decreases relative to the length of a portion electrically coupled to the electrode in the direction orthogonal to the potential gradient.

For the foregoing reasons, there is a need for a liquid crystal element capable of appropriately refracting light.

### SUMMARY

According to an aspect, a liquid crystal element includes: a first substrate and a second substrate overlapping each other in a plan view; and a liquid crystal layer disposed between the first and second substrates. The first substrate includes: a plurality of electric resistance films arranged in a first direction and a second direction orthogonal to the first direction in a plan view and each having a shape with a length in the first direction being longer than a length in the second direction; a plurality of first electrodes each including a first trunk part and first branch parts, the first trunk part extending in the second direction, the first branch parts protruding from the first trunk part to opposite sides in the first direction; and a plurality of second electrodes each including a second trunk part and second branch parts, the second trunk part extending in the second direction, the second branch parts protruding from the second trunk part to opposite sides in the first direction. Each of the electric resistance films is provided such that: the first and second trunk parts are disposed on sides opposite each other with the electric resistance film interposed between the trunk parts in the first direction; and the first and second branch parts are electrically coupled to the electric resistance film in a state of facing each other in the second direction.

### BRIEF DESCRIPTION OF THE DRAWINGS

FIG. 1 is a conceptual diagram of a liquid crystal element according to an embodiment of the present disclosure;

FIG. 2 is a plan view of the liquid crystal element according to the embodiment of the present disclosure;

FIG. 3 is a sectional view of the liquid crystal element along line III-III illustrated in FIG. 2;

FIG. 4 is a plan view illustrating the configuration of electric resistance films, first electrodes, and second electrodes;

FIG. 5 is a plan view illustrating the shape of a light-shielding film;

FIG. 6 is a diagram illustrating the potential of each electric resistance film and the phase difference of emission light passing through a liquid crystal layer when the liquid crystal element refracts emission light in a fourth direction;

FIG. 7 is a diagram illustrating the potential of each electric resistance film and the phase difference of emission light passing through the liquid crystal layer when the liquid crystal element refracts emission light in a fifth direction;

FIG. 8 is a plan view illustrating the configuration of the electric resistance films, the first electrodes, and the second electrodes in a liquid crystal element according to a modification of the embodiment of the present disclosure;

FIG. 9 is a sectional view of a liquid crystal element according to another modification of the embodiment of the present disclosure; and

FIG. 10 is a plan view illustrating the configuration of the electric resistance films, the first electrodes, and the second electrodes according to the other modification of the embodiment of the present disclosure.

### DETAILED DESCRIPTION

An embodiment of the present disclosure is described below with reference to the drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference signs are applied to the same elements as those already described for the previously mentioned drawings, and detailed explanations may be omitted as appropriate.

A first direction D1 and a second direction D2 illustrated in the drawings correspond to directions parallel to the plate surfaces of substrates included in a liquid crystal element 1. A side to which an arrow points in each direction corresponds to its positive side, and the opposite side corresponds to its negative side. The positive and negative sides in the first direction D1 and the positive and negative sides in the second direction D2 correspond to sides of the liquid crystal element 1. A third direction D3 corresponds to the thickness direction of the liquid crystal element 1, the positive side in the third direction D3 corresponds to the front surface side of the liquid crystal element 1, and the negative side in the third direction D3 corresponds to the back surface side of the liquid crystal element 1. In the present specification, a “plan view” is a view of the liquid crystal element 1 in the third direction D3. The first direction D1, the second direction D2, and the third direction D3 are exemplary, and the present disclosure is not limited to these directions.

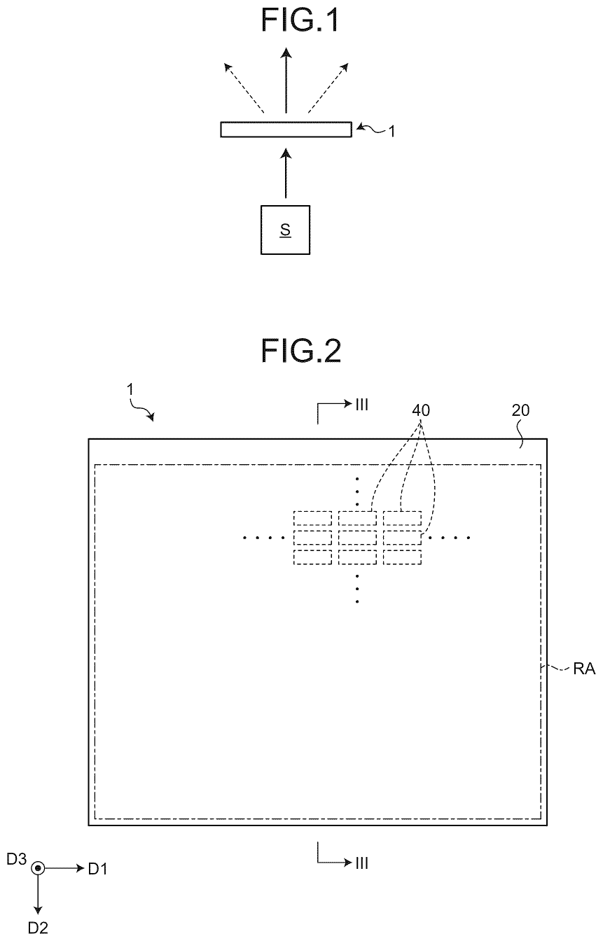

FIG. 1 is a conceptual diagram of the liquid crystal element 1 according to an embodiment of the present disclosure. The liquid crystal element 1 is a refractive plate that refracts light. Emission light L emitted from a light source S is incident on the liquid crystal element 1. The light source S is, for example, an illumination device such as a vehicle headlight or a spotlight.

When no voltage is applied, the liquid crystal element 1 transmits the emission light L as illustrated with the solid arrow without changing the direction (emission direction) in which the emission light L travels. When voltage is applied, the liquid crystal element 1 refracts the emission light L in one of two directions illustrated with the dashed arrows (to be described later in detail).

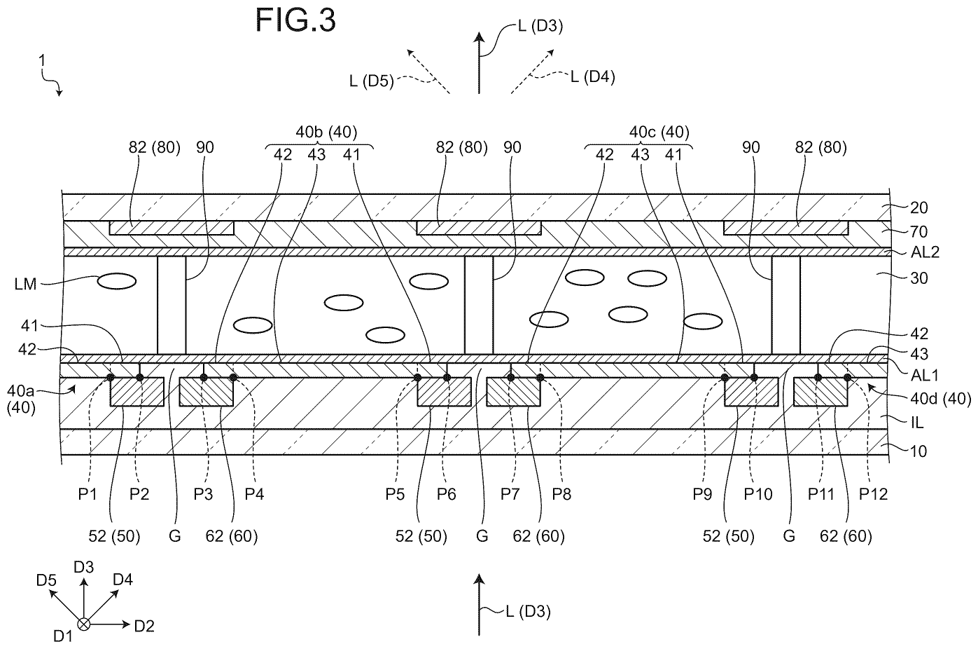

FIG. 2 is a plan view of the liquid crystal element 1 according to the embodiment of the present disclosure. FIG. 3 is a sectional view of the liquid crystal element 1 along line III-III illustrated in FIG. 2. The sectional view of the liquid crystal element 1 illustrated in FIG. 3 illustrates a sectional shape of the liquid crystal element 1 along a plane orthogonal to the first direction D1.

The liquid crystal element 1 includes a first substrate 10, a second substrate 20, and a liquid crystal layer 30.

The first substrate 10 and the second substrate 20 overlap each other in a plan view. The first substrate 10 and the second substrate 20 each have a light-transmitting property. The first substrate 10 and the second substrate 20 are, for example, glass substrates, resin substrates, or resin films.

A plurality of electric resistance films 40, a plurality of first electrodes 50, a plurality of second electrodes 60, an insulating layer IL, and a first alignment film AL1 are disposed on the first substrate 10.

As illustrated in FIG. 2, the electric resistance films 40 are arranged in a matrix of rows and columns in the first direction D1 and the second direction D2 in a plan view. In a plan view, the electric resistance films 40 each have a rectangular shape with the length in the first direction D1 being longer than the length in the second direction D2. In a plan view, the electric resistance films 40 overlap a refraction region RA that refracts the emission light L.

FIG. 3 illustrates four electric resistance films 40 arranged in the second direction D2. A first electric resistance film 40a, a second electric resistance film 40b, a third electric resistance film 40c, and a fourth electric resistance film 40d illustrated in FIG. 3 are arranged in the stated order from the negative side toward the positive side in the second direction D2.

The electric resistance values of the electric resistance films 40 are larger than the electric resistance values of the first electrodes 50 and the second electrodes 60. The material of the electric resistance films 40 is a light-transmitting conductive material such as zinc oxide (ZnO) or indium gallium zinc oxide (IGZO).

As illustrated in FIG. 3, the first and second electrodes 50 and 60 are disposed on the back surface side of the electric resistance films 40.

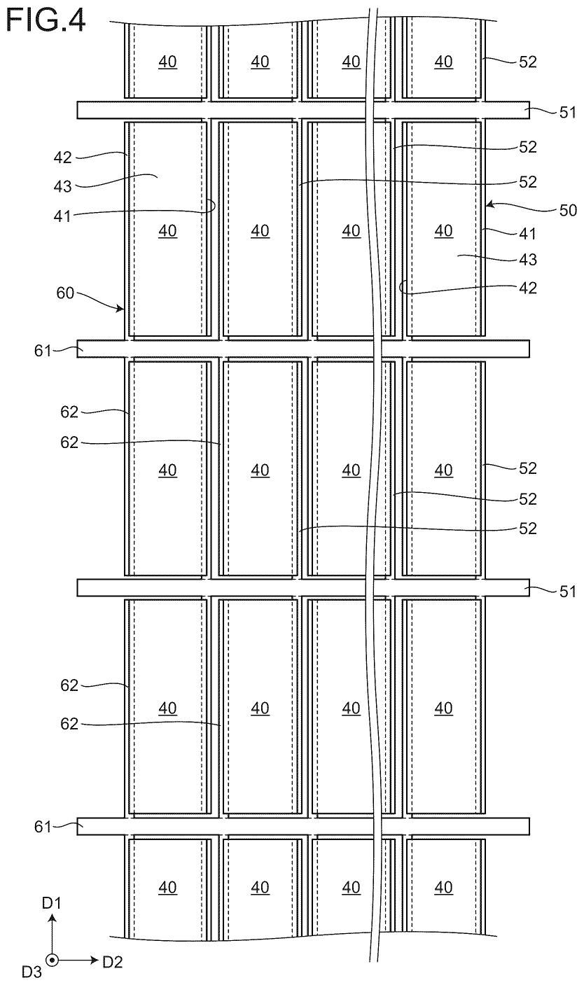

FIG. 4 is a plan view illustrating the configuration of the electric resistance films 40, the first electrodes 50, and the second electrodes 60. Each first electrode 50 integrally includes a first trunk part 51 and a plurality of first branch parts 52.

The first trunk part 51 extends in the second direction D2. The first trunk part 51 is disposed between two electric resistance films 40 adjacent to each other in the first direction D1. The first trunk part 51 is separated from the electric resistance films 40 in a plan view.

The first branch parts 52 protrude from the first trunk part 51 to opposite sides in the first direction D1. The first branch parts 52 extend in the first direction D1. The first branch parts 52 are electrically coupled to two electric resistance films 40 adjacent to each other with the first trunk part 51 interposed therebetween in the first direction D1. As illustrated in FIGS. 3 and 4, the first branch part 52 is electrically coupled to an end part of the electric resistance film 40 on the positive side in the second direction D2. The first branch part 52 contacts the electric resistance film 40.

As illustrated in FIG. 4, each second electrode 60 integrally includes a second trunk part 61 and a plurality of second branch parts 62.

The second trunk part 61 extends in the second direction D2. The second trunk part 61 is disposed between two electric resistance films 40 adjacent to each other in the first direction D1. The second trunk part 61 is separated from the electric resistance films 40 in a plan view.

For each electric resistance film 40, the first trunk part 51 and the second trunk part 61 are disposed on opposite sides with the electric resistance film 40 interposed therebetween in the first direction D1. In other words, the first and second trunk parts 51 and 61 are alternately arranged in the first direction D1.

The second branch parts 62 protrude from the second trunk part 61 to opposite sides in the first direction D1. The second branch parts 62 extend in the first direction D1. The second branch parts 62 are electrically coupled to two electric resistance films 40 adjacent to each other with the second trunk part 61 interposed therebetween in the first direction D1. As illustrated in FIGS. 3 and 4, the second branch part 62 is electrically coupled to an end part of the electric resistance film 40 on the negative side in the second direction D2. The second branch part 62 contacts the electric resistance film 40.

In each electric resistance film 40, the first branch part 52 and the second branch part 62 are electrically coupled to the electric resistance film 40 in a state in which the first branch part 52 and the second branch part 62 face each other in the second direction D2. The length of the first branch part 52 in the first direction D1 at a portion electrically coupled to an end part of the electric resistance film 40 is equal to the length of the second branch part 62 in the first direction D1 at a portion electrically coupled to an end part of the electric resistance film 40. Hereinafter, this length in the first direction D1 is referred to as a first electrode length.

The sectional shape of the first branch part 52 is the same as that of the second branch part 62. Accordingly, the length of the first branch part 52 in the second direction D2 is equal to the length of the second branch part 62 in the second direction D2. Hereinafter, the length in the second direction D2 is referred to as a second electrode length.

The material of the first and second electrodes 50 and 60 is a conductive material such as molybdenum tungsten alloy (MoW) or TAT (Ti/Al/Ti) in which titanium (Ti) and aluminum (Al) are stacked.

As illustrated in FIGS. 3 and 4, in each electric resistance film 40, a portion overlapping the first electrode 50 (first branch part 52) in a plan view is referred to as a first overlap portion 41; a portion overlapping the second electrode 60 (second branch part 62) in a plan view is referred to as a second overlap portion 42; and a portion between the first and second overlap portions 41 and 42 is referred to as a middle portion 43. In the second direction D2, the length of the middle portion 43 is longer than the sum of the length of the first overlap portion 41 and the length of the second overlap portion 42.

In the present embodiment, in the second direction D2, the positive end of the first branch part 52 is positioned on the positive side of the positive end of the electric resistance film 40, and the negative end of the second branch part 62 is positioned on the negative side of the negative end of the electric resistance film 40. In the second direction D2, the positive end of the first branch part 52 may coincide with the positive end of the electric resistance film 40, and the negative end of the second branch part 62 may coincide with the negative end of the electric resistance film 40.

The insulating layer IL illustrated in FIG. 3 electrically insulates the electric resistance films 40, the first trunk parts 51, and the second trunk parts 61 from one another. The insulating layer IL also electrically insulates the first electrodes 50 and the second electrodes 60 from each other.

The first alignment film AL1 is disposed on the front surface side of the electric resistance film 40.

A third electrode 70 and a second alignment film AL2 are disposed on the second substrate 20. The third electrode 70 overlaps the electric resistance films 40 in a plan view.

The material of the third electrode 70 is a light-transmitting conductive material such as indium tin oxide (ITO), indium zinc oxide (IZO), indium gallium oxide (IGO), or indium gallium zinc oxide (IGZO).

The electric resistance value (hereinafter referred to as a film resistance value) and shape of the electric resistance films 40 and the electric resistance value (hereinafter referred to as an electrode resistance value) and shape of the first and second electrodes 50 and 60 are set such that a resistance ratio described below is appropriate. In a case where the resistance ratio is not appropriately set, a potential gradient to be described later is not appropriately generated in the electric resistance films 40 and the liquid crystal element 1 cannot appropriately refract the emission light L.

The potential gradient in each electric resistance film 40 is generated along the second direction D2 between the first branch part 52 and the second branch part 62 in a plan view. The first direction D1 is orthogonal to the direction in which the potential gradient is generated. The resistance ratio is the ratio of the film resistance value in the second direction D2 to the electrode resistance value in the first direction D1 and expressed by Expression (1) below.

$$Ra = Rfd 2 / Red 1 \qquad ( 1 )$$

In Expression (1), Ra represents the resistance ratio, Red1 represents the electrode resistance value in the first direction D1, and Rfd2 represents the film resistance value in the second direction D2.

The film resistance value (Rfd2) in the second direction D2 in Expression (1) is expressed by Expression (2) below.

$$Rfd 2 = Rf \times ( Lf 2 / Lf 1 ) \qquad ( 2 )$$

In Expression (2), Rf represents the film resistance value. In addition, Lf1 represents the length of the portions of the electric resistance film 40 in the first direction D1 that are electrically coupled to the first electrode 50 (first branch part 52) and the second electrode 60 (second branch part 62), respectively (that is, corresponds to the first electrode length). Furthermore, Lf2 represents a length by which the potential gradient is generated in the electric resistance film 40, and the length of the middle portion 43 in the second direction D2 between the first branch part 52 and the second branch part 62 in a plan view.

The electrode resistance value (Red1) in the first direction D1 in Expression (1) is expressed by Expression (3) below.

$$Red 1 = R e \times ( Le 1 / Le 2 ) \qquad ( 3 )$$

In Expression (3), Re represents the electrode resistance value, Le1 represents the first electrode length (length of portions of the first branch part 52 and the second branch part 62 in the first direction D1 that are electrically coupled to the respective end parts of the electric resistance film 40), and Le2 represents the second electrode length (length of the first branch part 52 and the second branch part 62 in the second direction D2).

The potential gradient needs to be increased to increase the refraction angle of the emission light L. To increase the potential gradient, the length (Lf2) of the electric resistance film 40 in the second direction D2 is shortened. However, the resistance ratio has an appropriate range of 100 to 1000 inclusive. From Expressions (1), (2), and (3), the resistance ratio decreases and potentially becomes lower than the appropriate range when the length (Lf2, Le2) in the second direction D2 is shorter than the length (Lf1, Le1) in the first direction D1 in the electric resistance film 40, the first branch part 52, and the second branch part 62.

Thus, the shapes of the electric resistance film 40, the first branch part 52, and the second branch part 62 are determined so that the resistance ratio falls within the appropriate range, and the electric resistance films 40 are arranged in a matrix of rows and columns in the first direction D1 and the second direction D2. In other words, the electric resistance films 40 are formed into shapes in which the length (Lf2) in the second direction D2 relative to the length (Lf1) in the first direction D1 is adjusted so that the resistance ratio falls within the appropriate range, and the electric resistance films 40 having such shapes are arranged.

As illustrated in FIG. 3, the second alignment film AL2 is disposed on the back surface side of the third electrode 70.

The liquid crystal layer 30 is positioned between the first substrate 10 and the second substrate 20. The liquid crystal layer 30 is sandwiched between the first alignment film AL1 and the second alignment film AL2. The first alignment film AL1 and the second alignment film AL2 determine the alignment (initial alignment) of liquid crystal molecules LM contained in the liquid crystal layer 30 when no voltage is applied to the liquid crystal element 1. The alignment direction of the first alignment film AL1 and the alignment direction of the second alignment film AL2 are parallel to each other in a plan view.

The liquid crystal element 1 is an electrically controlled birefringence (ECB) liquid crystal element. However, the liquid crystal element 1 is not limited to an ECB liquid crystal element.

The liquid crystal element 1 further includes a light-shielding film 80 and a photo spacer 90.

The light-shielding film 80 interrupts light transmission. The light-shielding film 80 has conductivity. The material of the light-shielding film 80 is, for example, molybdenum tungsten alloy (MoW). The light-shielding film 80 is disposed on the second substrate 20. The light-shielding film 80 is disposed between the second substrate 20 and the third electrode 70.

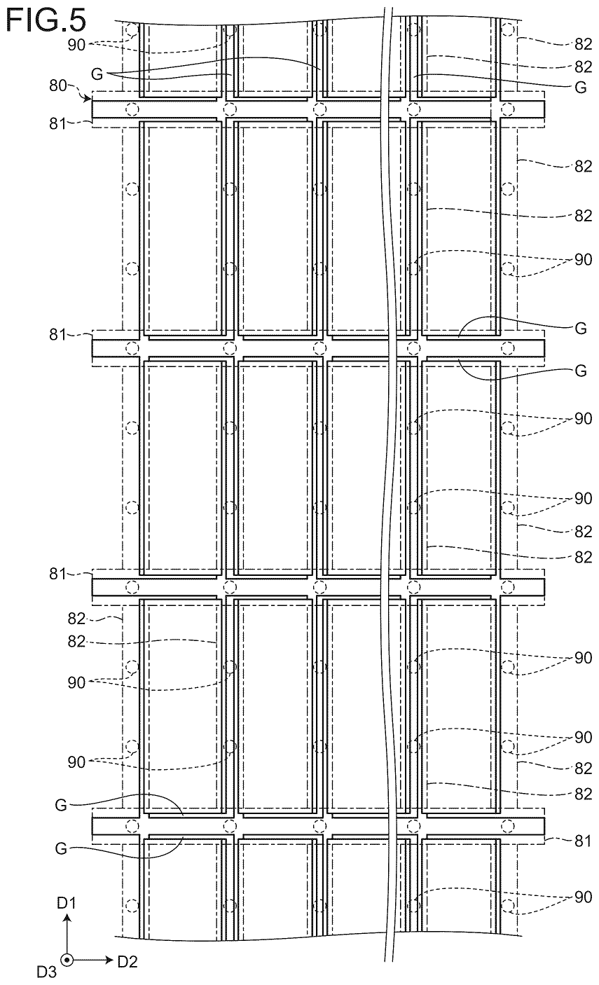

FIG. 5 is a plan view illustrating the shape of the light-shielding film 80. In FIG. 5, the light-shielding film 80 is illustrated with dashed and single-dotted lines. As illustrated in FIGS. 3 and 5, the light-shielding film 80 overlaps gaps G between two electric resistance films 40 adjacent to each other in a plan view. The light-shielding film 80 also overlaps the first and second electrodes 50 and 60 in a plan view. The light-shielding film 80 integrally includes a plurality of first light-shielding parts 81 and a plurality of second light-shielding parts 82.

The first light-shielding parts 81 each have a strip shape extending in the second direction D2. The first light-shielding parts 81 each overlap a gap G between two electric resistance films 40 adjacent to each other in the first direction D1 in a plan view. The first light-shielding parts 81 are arranged in the first direction D1.

The second light-shielding parts 82 each have a strip shape extending in the first direction D1. The second light-shielding parts 82 each couple two first light-shielding parts 81 adjacent to each other in the first direction D1. The second light-shielding parts 82 each overlap a gap G between two electric resistance films 40 adjacent to each other in the second direction D2 in a plan view.

A plurality of the photo spacers 90 are disposed between the first substrate 10 and the second substrate 20. The photo spacers 90 have column shapes and keeps the thickness of the liquid crystal layer 30 constant. The photo spacers 90 overlap the light-shielding film 80 in a plan view.

The following describes operation when the liquid crystal element 1 refracts the emission light L from the light source S. The emission light L is incident on the liquid crystal element 1 in the third direction D3 from the back surface of the first substrate 10. A reference sign inside parentheses assigned to the emission light L indicates the direction in which the emission light L travels. In FIG. 3, an arrow illustrating the emission light L from the liquid crystal element 1 is illustrated on the positive side of the liquid crystal element 1 in the third direction D3.

When no potential is applied to the liquid crystal element 1, the emission light L from the liquid crystal element 1 travels in the third direction D3. When potential is applied to the liquid crystal element 1, the emission light L from the liquid crystal element 1 travels in a fourth direction D4 or a fifth direction D5 as described later. In other words, when potential is applied, the liquid crystal element 1 refracts the emission light L in the fourth direction D4 or the fifth direction D5.

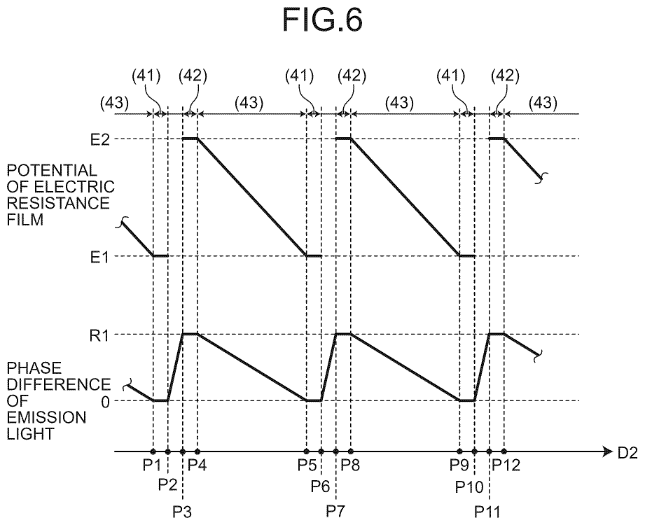

FIG. 6 is a diagram illustrating the potential of each electric resistance film 40 and the phase difference of the emission light L passing through the liquid crystal layer 30 when the liquid crystal element 1 refracts the emission light L in the fourth direction D4. The fourth direction D4 is a direction tilted on the positive side in the second direction D2 relative to the third direction D3 as illustrated in FIG. 3.

Points on the horizontal axis representing the second direction D2 illustrated in FIG. 6 indicate positions in the second direction D2. An arrow corresponding to a reference sign inside parentheses illustrated in FIG. 6 indicates the region of a portion of the electric resistance film 40. FIG. 3 also illustrates the points indicating the positions in the second direction D2.

A first point P1 and a second point P2 illustrated in FIGS. 3 and 6 correspond to the negative end of the first overlap portion 41 and the positive end of the first overlap portion 41 in the first electric resistance film 40a illustrated in FIG. 3.

A third point P3, a fourth point P4, a fifth point P5, and a sixth point P6 illustrated in FIGS. 3 and 6 correspond to the negative end of the second overlap portion 42, the positive end of the second overlap portion 42, the negative end of the first overlap portion 41, and the positive end of the first overlap portion 41 in the second electric resistance film 40b illustrated in FIG. 3.

A seventh point P7, an eighth point P8, a ninth point P9, and a tenth point P10 illustrated in FIGS. 3 and 6 correspond to the negative end of the second overlap portion 42, the positive end of the second overlap portion 42, the negative end of the first overlap portion 41, and the positive end of the first overlap portion 41 in the third electric resistance film 40c illustrated in FIG. 3.

An eleventh point P11 and a twelfth point P12 illustrated in FIGS. 3 and 6 correspond to the negative end of the second overlap portion 42 and the positive end of the second overlap portion 42 in the fourth electric resistance film 40d illustrated in FIG. 3.

When the liquid crystal element 1 refracts the emission light L in the fourth direction D4, a first potential E1 is applied to the first electrodes 50 and a second potential E2 higher than the first potential E1 is applied to the second electrodes 60 by a non-illustrated control circuit.

In this case, in one electric resistance film 40, the potential of the second overlap portion 42 (for example, portion between the third point P3 and the fourth point P4 in the second electric resistance film 40b) contacting the second electrode 60 is equal to the second potential E2. In one electric resistance film 40, the potential of the middle portion 43 (for example, portion between the fourth point P4 and the fifth point P5 in the second electric resistance film 40b) between the first electrode 50 and the second electrode 60 linearly changes from the second potential E2 to the first potential E1 from the negative side toward the positive side in the second direction D2. In one electric resistance film 40, the potential of the first overlap portion 41 (for example, portion between the fifth point P5 and the sixth point P6 in the second electric resistance film 40b) contacting the first electrode 50 is equal to the first potential E1.

The first potential E1 is applied to the third electrode 70 by the control circuit. The potential difference between the first potential E1 and the second potential E2 is determined based on the angle between the third direction D3 and the fourth direction D4. In other words, the degree of the tilt of the fourth direction D4 relative to the third direction D3 can be adjusted by the potential difference between the first potential E1 and the second potential E2.

An electric field generated by potential application to the first electrodes 50, the second electrodes 60, and the third electrode 70 acts on the liquid crystal layer 30 and tilts the liquid crystal molecules LM. Accordingly, the refractive index of the emission light L in the liquid crystal layer 30 changes in the second direction D2, and a phase difference occurs to the emission light L passing through the liquid crystal layer 30.

As for the phase of the emission light L passing through the liquid crystal layer 30 illustrated in FIG. 6, the phase at a position corresponding to the most positive end of one electric resistance film 40 in the second direction D2 (for example, the sixth point P6 in the second electric resistance film 40b) is taken as a reference (where the phase difference is 0 (zero)), and the maximum value of a phase difference caused by potentials applied to the first and second electrodes 50 and 60 is referred to as the first phase difference R1. A solid line representing the phase difference of the emission light L illustrated in FIG. 6 has a locus with the same phase as the reference phase.

The phase difference of the emission light L passing through the liquid crystal layer 30 changes in a zigzag pattern between 0 (zero) and the first phase difference R1 in the second direction D2. Specifically, the phase difference at portions of the liquid crystal layer 30 corresponding to the second overlap portions 42 is the first phase difference R1. The phase difference at portions of the liquid crystal layer 30 corresponding to the middle portion 43 changes from the first phase difference R1 to 0 (zero) from the negative side toward the positive side in the second direction D2. The phase difference at portions of the liquid crystal layer 30 corresponding to the first overlap portion 41 is 0 (zero).

The phase difference between two electric resistance films 40 adjacent to each other in the second direction D2 (for example, between the second point P2 and the third point P3) changes from 0 (zero) to the first phase difference R1 from the negative side toward the positive side in the second direction D2.

The degree of the gradient of the phase difference at a portion of the liquid crystal layer 30 corresponding to the middle portion 43 corresponds to the angle between the third direction D3 and the fourth direction D4. In the second direction D2, the length of the portion of the liquid crystal layer 30 corresponding to the middle portion 43 is longer than the sum of the lengths of portions of the liquid crystal layer 30 corresponding to the first overlap portion 41 and the second overlap portion 42.

As the phase difference of the emission light L passing through the liquid crystal layer 30 changes as illustrated in FIG. 6, the emission light L is refracted in the liquid crystal layer 30 and exits in the fourth direction D4 from the liquid crystal element 1.

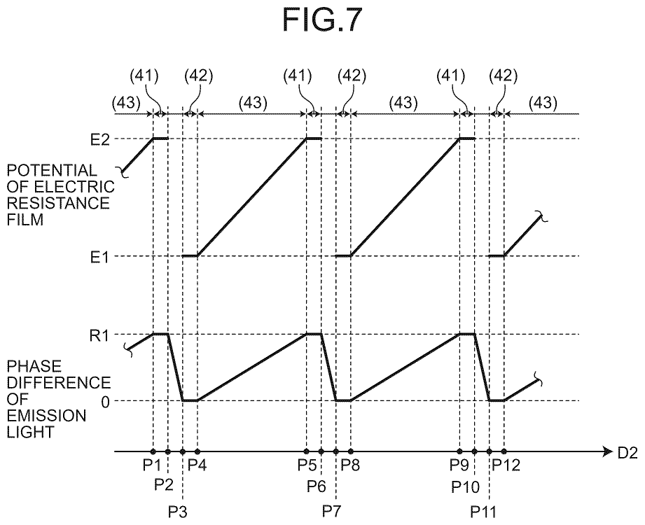

FIG. 7 is a diagram illustrating the potential of each electric resistance film 40 and the phase difference of the emission light L passing through the liquid crystal layer 30 when the liquid crystal element 1 refracts the emission light L in the fifth direction D5. The fifth direction D5 is a direction tilted on the negative side in the second direction D2 relative to the third direction D3 as illustrated in FIG. 3.

When the liquid crystal element 1 refracts the emission light L in the fifth direction D5, the second potential E2 is applied to the first electrodes 50 and the first potential E1 is applied to the second electrodes 60 by the control circuit.

In this case, as illustrated in FIG. 7, in one electric resistance film 40, the potential of the second overlap portion 42 (for example, portion between the third point P3 and the fourth point P4 in the second electric resistance film 40b) contacting the second electrode 60 is equal to the first potential E1. In one electric resistance film 40, the potential of the middle portion 43 (for example, portion between the fourth point P4 and the fifth point P5 in the second electric resistance film 40b) linearly changes from the first potential E1 to the second potential E2, from the negative side toward the positive side in the second direction D2. In one electric resistance film 40, the potential of the first overlap portion 41 (refer to FIG. 3; for example, portion between the fifth point P5 and the sixth point P6 in the second electric resistance film 40b) contacting the first electrode 50 is equal to the second potential E2.

The first potential E1 is applied to the third electrode 70 by the control circuit. The potential difference between the first potential E1 and the second potential E2 is determined based on the angle between the third direction D3 and the fifth direction D5. Thus, the degree of the tilt of the fifth direction D5 relative to the third direction D3 can be adjusted by the potential difference between the first potential E1 and the second potential E2.

Through potential application to the first electrodes 50, the second electrodes 60, and the third electrode 70, the refractive index of the emission light L in the liquid crystal layer 30 changes in the second direction D2, and a phase difference occurs to the emission light L passing through the liquid crystal layer 30.

As for the phase of the emission light L passing through the liquid crystal layer 30 illustrated in FIG. 7, the phase at a position corresponding to the most negative end of one electric resistance film 40 in the second direction D2 (for example, the third point P3 in the second electric resistance film 40b) is taken as a reference (where the phase difference is 0 (zero)), and the maximum value of a phase difference caused by potentials applied to the first and second electrodes 50 and 60 is referred to as the first phase difference R1.

The phase difference of the emission light L passing through the liquid crystal layer 30 changes in a zigzag pattern between 0 (zero) and the first phase difference R1 in the second direction D2. Specifically, the phase difference at a portion of the liquid crystal layer 30 corresponding to the second overlap portion 42 is 0 (zero). The phase difference at a portion of the liquid crystal layer 30 corresponding to the middle portion 43 changes from 0 (zero) to the first phase difference R1, from the negative side toward the positive side in the second direction D2. The phase difference at a portion of the liquid crystal layer 30 corresponding to the first overlap portion 41 is the first phase difference R1.

The phase difference between two electric resistance films 40 adjacent to each other in the second direction D2 linearly changes from the first phase difference R1 to 0 (zero), from the negative side toward the positive side in the second direction D2.

The degree of the gradient of the phase difference at a portion of the liquid crystal layer 30 corresponding to the middle portion 43 corresponds to the angle between the third direction D3 and the fifth direction D5.

As the phase difference of the emission light L passing through the liquid crystal layer 30 changes as illustrated in FIG. 7, the emission light L is refracted in the liquid crystal layer 30 and exits in the fifth direction D5 from the liquid crystal element 1.

As described above, the shapes of the electric resistance films 40, the first branch parts 52, and the second branch parts 62 are determined so that the resistance ratio is in the appropriate range, whereby the potential gradient is appropriately generated in the electric resistance films 40. Thus, the liquid crystal element 1 can appropriately refract the emission light L.

Moreover, the light-shielding film 80 can reduce the emission light L passing through the gaps G of the liquid crystal element 1 between two electric resistance films 40 adjacent to each other in a plan view. Accordingly, the emission light L passes through the electric resistance films 40, and the liquid crystal element 1 can appropriately refract the emission light L.

Since the material of the light-shielding film 80 is molybdenum tungsten alloy (MoW), the light-shielding film 80 can be thinned as compared to a case where the material is a non-conductive material (for example, resin material). Thus, the asperity height of the surface of the liquid crystal layer 30 on the positive side in the third direction D3 can be smaller. Accordingly, when the emission light L is refracted to travel in the fourth direction D4, the emission light L traveling in directions other than the fourth direction D4 in the liquid crystal layer 30 is reduced. Thus, the liquid crystal element 1 can appropriately refract the emission light L.

As described above, the photo spacers 90 overlap the light-shielding film 80 in a plan view. In this case, the emission light L interrupted by the photo spacers 90 is reduced as compared to a case where the photo spacers 90 are disposed at positions displaced from the light-shielding film 80 in a plan view. Thus, the liquid crystal element 1 can appropriately refract the emission light L. Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

For example, the light-shielding film 80 may be disposed on the first substrate 10. In this case, the material of the light-shielding film 80 is an electrically insulating material (for example, resin material). Thus, even when the light-shielding film 80 is positioned near the electric resistance films 40, the effects of the light-shielding film 80 on the potential gradient generated in the electric resistance films 40 can be reduced.

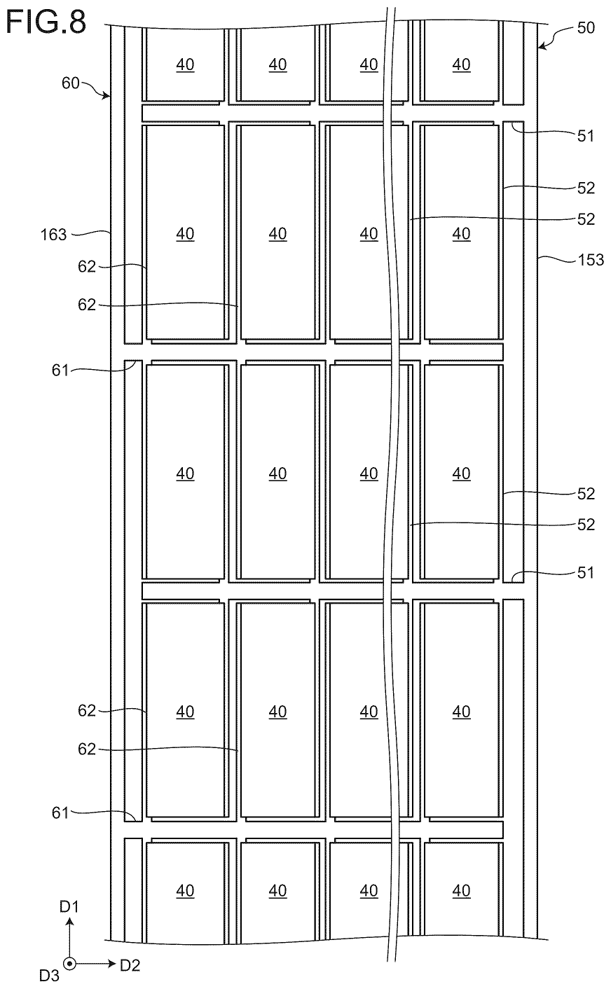

FIG. 8 is a plan view illustrating the configuration of the electric resistance films 40, the first electrodes 50, and the second electrodes 60 in the liquid crystal element 1 according to a modification of the embodiment of the present disclosure. In the present modification, the first electrodes 50 further include a first coupling part 153 (equivalent to “coupling part”). The second electrodes 60 further include a second coupling part 163.

On the outside of the electric resistance films 40 in a plan view, the first coupling part 153 couples the first trunk parts 51. The first coupling part 153 has a strip shape extending in the first direction D1.

On the outside of the electric resistance films 40 in a plan view, the second coupling part 163 couples the second trunk parts 61. The second coupling part 163 has a strip shape extending in the first direction D1.

The first coupling part 153 and the second coupling part 163 are positioned on sides opposite each other with the electric resistance films 40 interposed therebetween in the second direction D2.

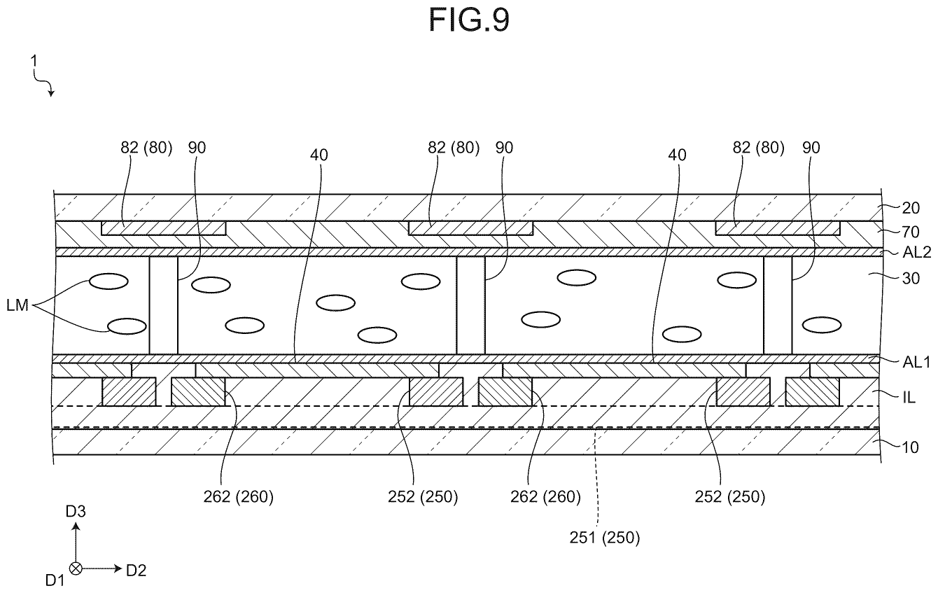

FIG. 9 is a sectional view of the liquid crystal element 1 according to another modification of the embodiment of the present disclosure. In the present modification, a first trunk part 251 and a first branch part 252 of a first electrode 250 are separated members. The first trunk part 251 has a strip shape extending in the second direction D2. The first branch part 252 has a strip shape extending in the first direction D1. The first trunk part 251 and the first branch part 252 are disposed at positions different from each other in the third direction D3. In the present modification, the first branch part 252 is disposed between the first trunk part 251 and the corresponding electric resistance film 40 in the third direction D3.

In the present modification, a second trunk part 261 and a second branch part 262 of a second electrode 260 are separated members. The second trunk part 261 has a strip shape extending in the second direction D2. The second branch part 262 has a strip shape extending in the first direction D1. The second trunk part 261 and the second branch part 262 are disposed at positions different from each other in the third direction D3. In the present modification, the second branch part 262 is disposed between the second trunk part 261 and the corresponding electric resistance film 40 in the third direction D3.

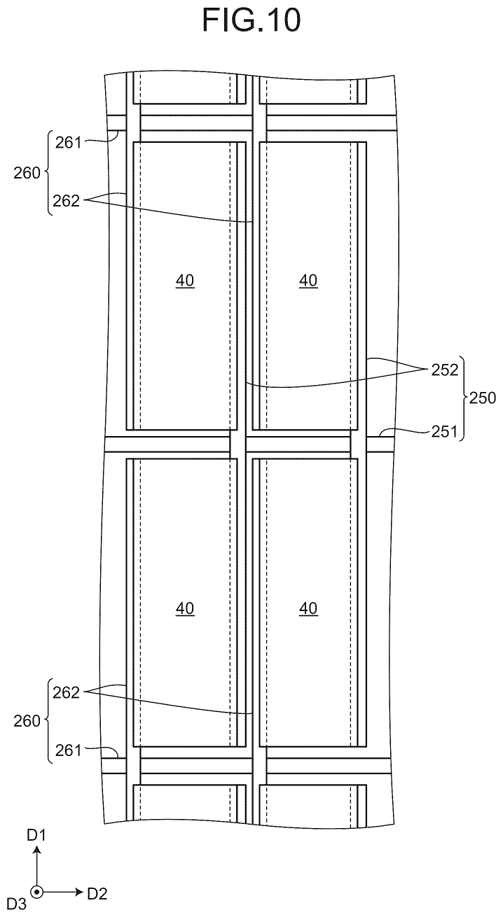

FIG. 10 is a plan view illustrating the configuration of the electric resistance films 40, the first electrodes 250, and the second electrodes 260 according to the other modification of the embodiment of the present disclosure. In a plan view, the arrangement of the electric resistance films 40, the first electrodes 250, and the second electrodes 260 is the same as the arrangement of the first electrodes 50 and the second electrodes 60 illustrated in FIG. 4. In each first electrode 250, the first trunk part 251 and the first branch part 252 are electrically coupled to each other at portions overlapping in a plan view. In each second electrode 260, the second trunk part 261 and the second branch part 262 are electrically coupled to each other at portions where the second trunk part 261 and the second branch part 262 overlap with each other in a plan view.

In the present modification, the material of the first and second branch parts 52 and 62 may be a light-transmitting conductive material such as indium tin oxide (ITO), indium zinc oxide (IZO), indium gallium oxide (IGO), or indium gallium zinc oxide (IGZO). In this case, the light transmittance of the liquid crystal element 1 can be improved, and the luminance of the emission light L emitted from the liquid crystal element 1 can be improved.

It should be understood that the present disclosure provides any other effects achieved by aspects described above in the above-described embodiments, such as effects that are clear from the description of the present specification or effects that could be thought of by the skilled person in the art as appropriate.

What is claimed is:

1. A liquid crystal element comprising:
a first substrate and a second substrate overlapping each other in a plan view; and
a liquid crystal layer disposed between the first and second substrates, wherein
the first substrate includes
a plurality of electric resistance films arranged in a first direction and a second direction orthogonal to the first direction in a plan view and each having a shape with a length in the first direction being longer than a length in the second direction,
a plurality of first electrodes each including a first trunk part and first branch parts, the first trunk part extending in the second direction, the first branch parts protruding from the first trunk part to opposite sides in the first direction, and
a plurality of second electrodes each including a second trunk part and second branch parts, the second trunk part extending in the second direction, the second branch parts protruding from the second trunk part to opposite sides in the first direction, and
each of the electric resistance films is provided such that:
the first and second trunk parts are disposed on sides opposite each other with the electric resistance film interposed between the trunk parts in the first direction; and
the first and second branch parts are electrically coupled to the electric resistance film in a state of facing each other in the second direction.

2. The liquid crystal element according to claim 1, wherein the first electrodes further include a coupling part that couples the first trunk parts on an outside of the electric resistance films in a plan view.

3. The liquid crystal element according to claim 1, wherein the first trunk part and the first branch part are disposed at positions different from each other in a third direction orthogonal to the first and second directions.

4. The liquid crystal element according to claim 1, further comprising a light-shielding film that overlaps gaps between two of the electric resistance films adjacent to each other in a plan view and interrupts light transmission.

5. The liquid crystal element according to claim 4, wherein the light-shielding film is disposed on the second substrate and has conductivity.

6. The liquid crystal element according to claim 4, further comprising a photo spacer disposed between the first and second substrates, wherein the photo spacer overlaps the light-shielding film in a plan view.
